(19) United States
(12) Patent Application Publication
(10) Pub. No.: US 2011/0011789 A1
(43) Pub. Date: Jan. 20, 2011

(54) Industrial fluid multiple filtering assembly

(76) Inventor: William D. Hoff, Rochester, MI (US)

Correspondence Address: WILLIAM W. HAEFLIGER, 201 S. LAKE AVE, SUITE 512, PASADENA, CA, 91101, US

(21) Appl. No.: 12/460,058

(22) Filed: Jul. 14, 2009

(51) Int. Cl. B01D 33/067

(52) U.S. Cl. 210/362

(57) ABSTRACT

An individual component assembly for filtering fluid, comprising, in combination a centrifuge device operable to filter said fluid, stand structure mounting the centrifuge device, to be directly accessible, at least one fluid filter connected in operating flow passing series with the centrifuge, and openly and accessibly carried by the stand structure, pumping means associated with the stand structure for pumping fluid to flow through said fluid filter and then through the centrifuge.

### BACKGROUND OF THE INVENTION

This invention relates generally to centrifuging of fluids to separate solid contaminate from such fluids; and more particularly concerns highly effective and efficient centrifuging apparatus operating at very high rates of rotation, and methods of operation.

There is continual need for more efficient compact, reliable, simple and effective centrifuging equipment, and capable of removing micron size particulate from fluids, such as engine fuel and hydraulic fluids. The present invention provides apparatus and methods that meet such needs. The disclosure of U.S. Pat. No. 6,294,091 is incorporated herein by reference.

### SUMMARY OF THE INVENTION

It is a major object of the invention to provide improved centrifuging apparatus that comprises, in combination:

a) a centrifuge device operable to filter such fluid,

b) stand structure accessibly mounting the centrifuge,

c) at least one fluid filter connected in operating flow passing series with the centrifuge, and accessibly carried by the stand structure,

d) pumping means for pumping fluid to flow through the fluid filter and through the centrifuge.

As will be seen, an additional fluid filter may be connected in operation flow passing series with one filter and the centrifuge, and carried by the stand structure. In this regard, the one filter in the assembly is preferably a pre-filter operable to filter fluid prior to fluid delivery to the centrifuge, and the additional filter polishes, i.e. finally cleans fluid communicated from the centrifuge, and may have filtering media to capture the finest particulate possibly remaining in the filtrate.

The apparatus also preferably includes pumping means for pumping fluid to flow through the fluid filter and through the centrifuge, and the centrifuge device is preferably located at the top of the stand structure. The two additional filters are typically accessibly carried at external sides of the stand structure, to provide a highly compact efficient assembly, with directly accessible clustered components enabling rapid filtering media changes.

A further object is to provide an assembly in which a centrifuge drive turbine is located directly below the centrifuge chamber and at the top of the stand structure.

A highly compact portable assembly is provided with multiple directly accessible multiple filters and hoses, located externally of a support stand, for direct access.

These and other objects and advantages of the invention, as well as the details of an illustrative embodiment, will be more fully understood from the following specification and drawings, in which:

### DRAWING DESCRIPTION

FIG. 1 is a frontal elevation showing a preferred industrial component assembly incorporating the invention;

FIG. 2 is a rear elevation of the FIG. 1 assembly;

FIG. 3 is a view like FIG. 2, but showing flow paths via hoses;

FIG. 4 shows details of a centrifuge and a turbine rotating the centrifuge chamber; and

FIG. 4a shows jetted fluid impinging on fixed and angled surfaces.

### DETAILED DESCRIPTION

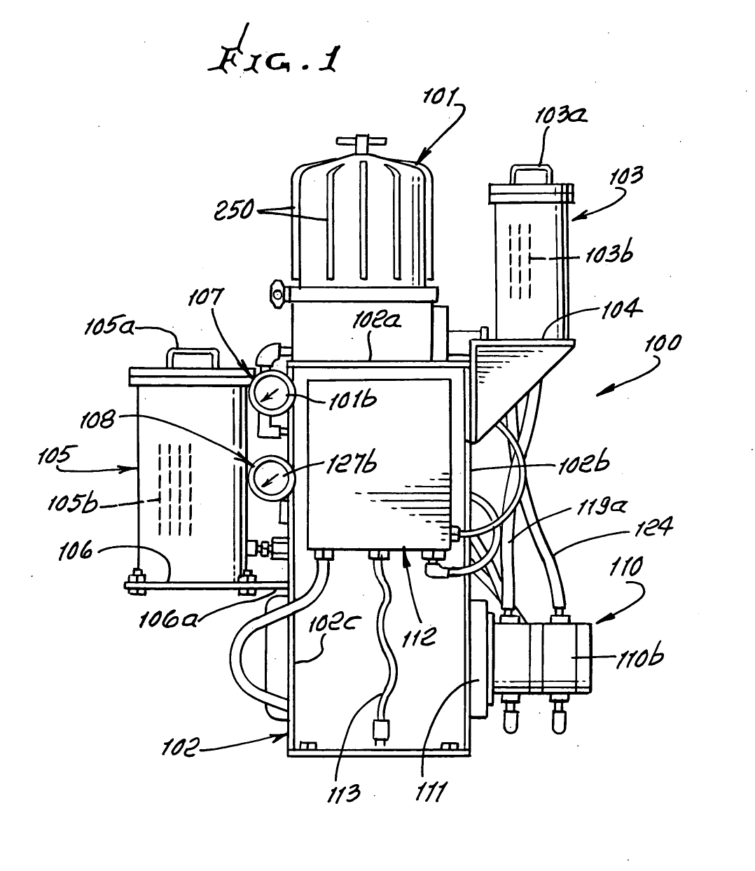

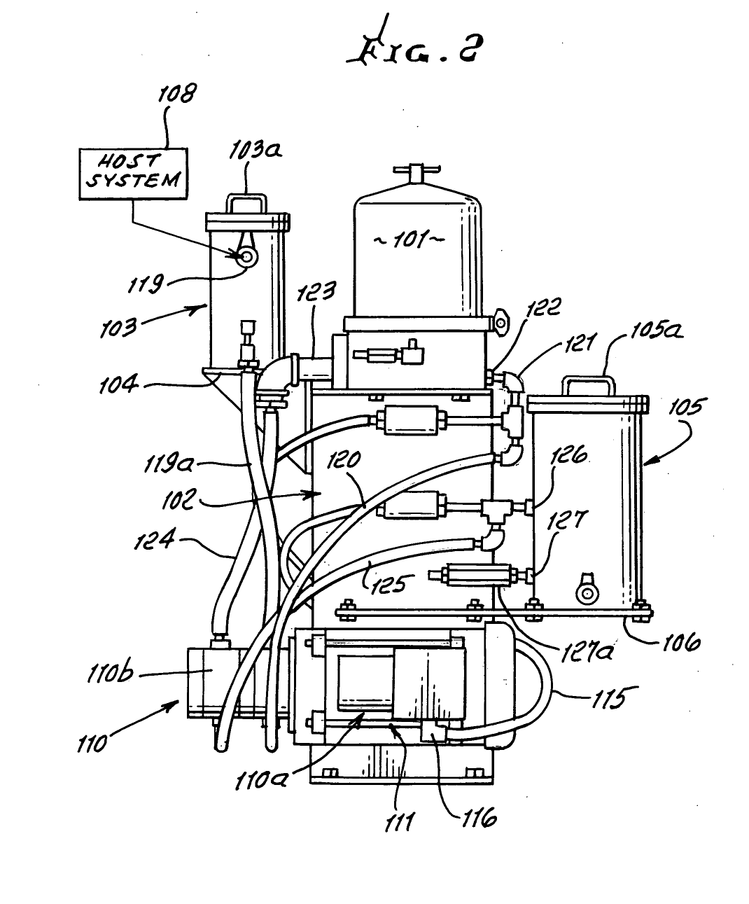

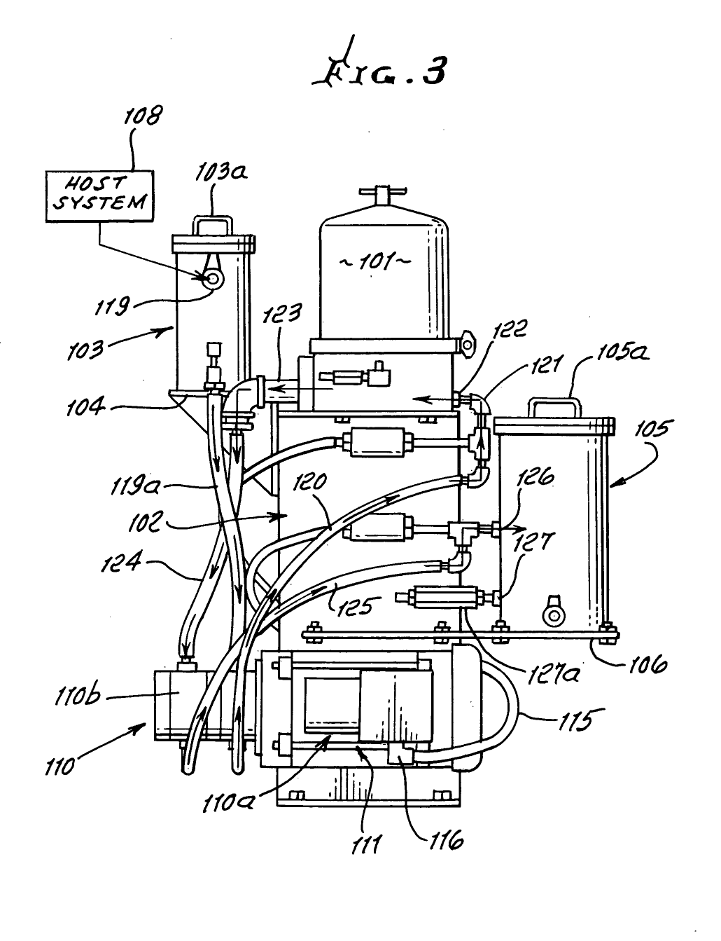

In FIGS. 1-3, the industrial component assembly 100 includes fluid filtering components that are directly easily accessible. They include a centrifuge device 101 mounted at the top 102a of a support stand 102, a pre-filter unit 103 connected in flow passing operative series with device 101 and carried at the right upper side of the stand as by a bracket 104 attached to side wall 102b of the stand; and a fluid polishing filter unit 105 connected in flow receiving series relation with the centrifuge unit. Unit 105 is carried at the lower left side of the stand, as on a bracket 106 attached at 106a to left side 102c of the stand. Two fluid pressure gauges 107 and 108 are located in close association with 105, to display the pressure of fluid discharged from the centrifuge, and the pressure of fluid discharged from filter 105. Lift-off handles for the tops of the filter units 103 and 105, are provided at 103a and 105a, enabling easy direct downward access to the filter media 103b and 105b therein, as for replacement.

A fluid pumping device 110 is attached to the lower portion of stand side wall 102b, as by connection 111. A pump motor speed controller 112 is protectively supported within the stand, directly below the centrifuge. Fluid to be centrifuged may comprise oil, as from an engine or other machine component, which contains contaminate such as metal particulate to be separated from the fluid by successive filtering stages at 101, 103 and 105. Filter 101 removes larger particles; filter 103 efficiently an d assuredly removes intermediate size and smaller particles; and polishing filter 105 removes smallest particles possibly remaining in the fluid.

A D.C. electric power supply cord is shown at 113. Pumping device 110 may comprise a two-stage gear pump having an A.C. drive motor 110a to which an A.C. power line 115 is connected, as from a power inverter 116.

Fluid flows from a host reservoir 108 to the inlet 119 to pre-filter 103, and discharges via hose or line 119a to flow to the gear pump stage 110a. Fluid discharges from stage 110a and flows via line 120 and tubing 121 to enter the centrifuge unit 101 at 122.

Fluid discharges from 101 at 123, and flows downward via line or hose 124 to the second stage 110b of the gear pump. From there, fluid flows via line 125 to enter the polishing filter 105 at 126. Fluid exits the polishing filter at outlet 127 to flow via check valve 127a to subsequent equipment, or to the host reservoir. When the polishing filter fills with contaminant, a pressure sensor and switch operates to shut down the system, via controls at 112. See pressure gauge 127b. A centrifuge pressure gauge is shown at 101b.

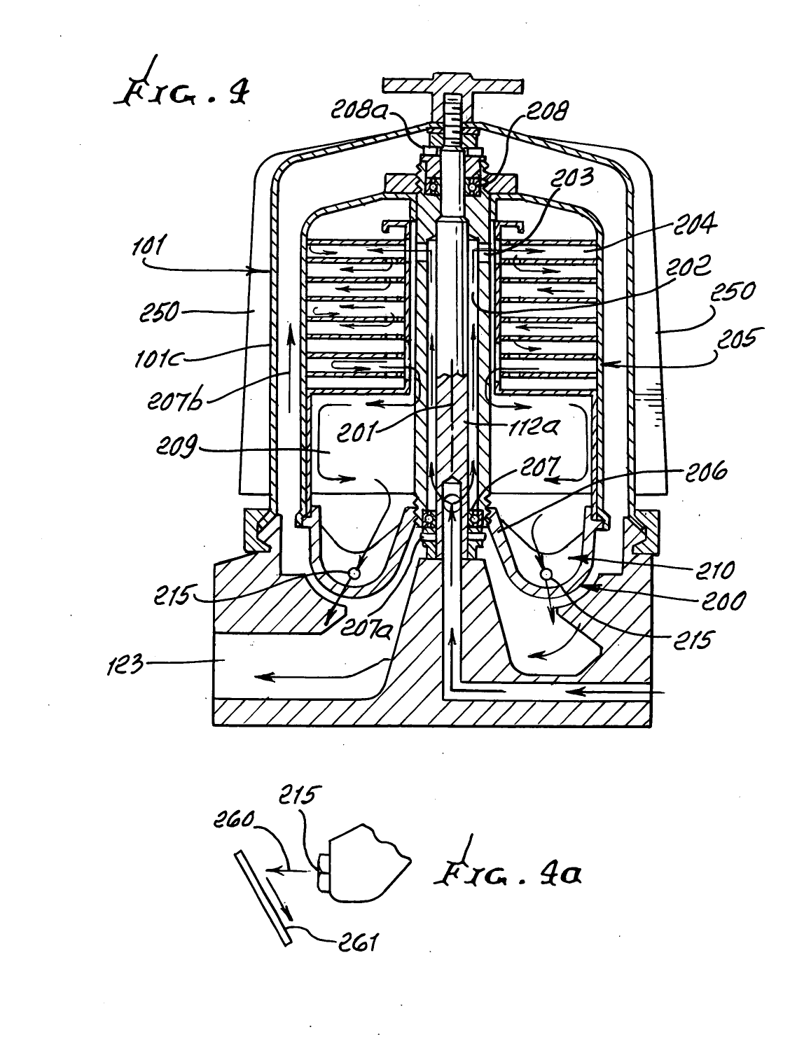

The centrifuge unit 101 may be of the general type as shown in FIG. 4, to be driven via the upright shaft 112a coupled to a turbine 200, and to the centrifuge. Unit 101 includes:
i) upright shaft 112a, defining an axis 201,
ii) porting 202 extending endwise in the shaft and opening radially laterally at 203 to the centrifuge interior to deliver flow to be centrifuged,
iii) sequentially connected generally radial passages 204 in the centrifuge chamber 205 in which contaminate in the delivered fluid is centrifuged for separation from the fluid, during chamber high-speed rotation;
iv) a rotor 206 supporting the chamber for rotation about the axis 201, there being at least one outlet 209 for fluid discharged from the chamber,
v) a fluid pressure driven turbine 210 connected in driving relation with the rotor, and receiving pressurized fluid from outlet 209. The turbine rotation about axis 201.

Cooling fins 250 may be provided on outer housing 101c, to radiate heat developed in response to rotation of the centrifuge. The housing and fins may consist of copper, or copper alloy, for efficient heat conduction.

The pumping means 110b is connected by line 124 with the turbine outlet to discharge at 125 to the polishing filter 105.

The turbine, as seen in FIG. 4, has jet port outlets at 215 to jet fluid directionally normal to the plane of FIG. 4, for driving the turbine about axis 201 at high speed. Mist from jetted fluid rises and lubricates high speed bearings 207 and 208. (See path 207a) and thrust (needle) bearings 207a and 208a. Shaft 112a is driven by rotor 206. FIG. 4a shows jetted fluid (oil) 260 impinging on fixed and angled surfaces 261, for return to 123.

Advantages of the invention, and claimed improved results:
1) Removes particle contaminants from very large sized solid particulate down to as low as a tenth of a micron in size and less. Solid particulates, if not removed, cause wear and impair functions of close tolerance components in any lubrication system.
2) Removes degradated oil (coked or burnt) contaminant sludge which otherwise causes changes in viscosity of the fluid as well as coked oil which may develop into an abrasive cinder-like contaminant.
3) Insures reliable operations of and increases overall engine, transmission, and hydraulic system efficiencies, by elimination of contaminants and sludge.
4) Reduces lubrication system operating temperatures by removing wear-metal and other friction causing contamination, and thereby increases over all film-strength of the lubrication oil/fluid. For example, engine oil analysis test conducted show removal of iron wear metals down to as low as “2 ppm”, and “0 ppm”. Reduction in wear of metals reduces the friction within the oil to the point where current overall engine oil operating temperatures are reduced by as much as 30 to 60 percent (depending upon moderate to adverse driving conditions and loads).
5) Provides increased engine horsepower due to overall cooler operating engine temperatures.
6) Reduced engine oil temperature is achieved by the following:
   i. Removal of heat causing friction wear metals (oil analysis test show just over a 97% reduction in parts per million (ppm) of iron wear metal, and 100% reduction in all other engine wear metals)
   ii. Removal of heat-holding heavy carbon particles and degradated oil or grease
   iii. Items I and ii above allow the oil or lubrication fluid to become less saturated with heat retaining contaminants and in turn the host fluid becomes “more wet” (not moisture related) therefore becoming less saturated with solids allowing for optimum heat exchange/transfer capability to occur from the engine or host equipment to the oil/fluid, than from the oil/fluid to the on-board or existing cooling system; on a continual cycle.
   iv. It will be noted that engine oil molecules and their additives breakdown or degrade under exposure to heat between and exceeding 140 to 150 degrees Fahrenheit. Another attribute is that the oil cleanliness levels achieved have allowed current diesel engine oil operating temperature test results not to exceed 126 degrees Fahrenheit. Therefore, in this case, the oil molecule and their additives degradation heat threshold/limit is never exceeded. Current independent oil analyses demonstrate that the diesel engine oil's additive package, oil viscosity and lubricity preserved.
   v. Acid is another cause for oil molecules and oil additives breakdown. The present oil-driven centrifuge configuration for example, removes carbon which is part of an acidic compound. Additionally, moisture is another element in acid formation. The present oil driven centrifuge removes over 99.9% of moisture (free water and dissolved water) from the engine oil crankcase. The effective moisture removal from the engine oil causes the crankcase to be free from 99.9% of moisture, also evident in assisting the lowering of emissions' moisture levels (CO2) in combustion processes regarded as being directly correlated.
   vi. Additionally, a particle analysis actually performed without dilution demonstrates a 22/19/11 ISO cleanliness code. Particle analyses are generally only performed on hydraulic oil, but rarely on engine oil (unless the engine oil comes directly out of a new bottle) since engine oil's standard carbon contamination saturation and soot index is usually much higher, which usually blocks particle analyzers from counting.
   vii. Oil additives remain preserved for longer periods of time for the life of the oil and possibly the host machinery.
7) Extends host machinery, seals, and other components life expectancy. Achieves reductions in engine, transmission, and brake/steering hydraulic system maintenance and repair costs, and increases life-span of machinery components by reducing wear rates up to 97% or higher. Old seals and new seals alike also remain preserved.
8) Achieves reduced equipment down time and reduced major engine and transmission repair/overhaul.
9) Maintains dimensional consistencies of moving parts due to reduced wear. Note: In standard diesel engines with standard oil filtration, contamination build-up will form behind piston rings, eventually pushing the rings outward, causing scoring and direct wear of the cylinder walls. Cylinders with heavy wear usually form a tapering wear pattern along the cylinder walls due to the sticky, seized or permanently stuck or pushed out rings. The taper in the cylinders will create a space between the piston ring and the cylinder which dramatically increases the rate of blow-by or engine emissions, due to reduced cylinder compression ratios in significant proportions. When compression is reduced, increased amounts of hydrocarbons or unburned fuel become present in the firing or combustion chamber. Piston rings are designed to create a seal between the piston and cylinder. Piston rings are also designed to actuate along the cylinder wall, but when heavy contamination is present, this limits the actuating function of the piston ring itself.
With use of the present centrifuge, contamination build-up is reduced and eventually totally removed over a relatively short period of time (depending upon the age and current wear of an engine prior to installation) allowing the piston rings to seal and actuate more effectively, as designed to perform. The cleaner and cooler operating engine oil is characterized by increased oil film-strength, which maximizing the seals between the piston rings and cylinder walls, and therefore enables increased compression ratios for more complete burn of fuel. Current test results demonstrate visibly no PM (particle matter), nor blow-by, and zero “0” HC's (hydrocarbons—unburned fuel), and zero “0” NO's (nitrous oxides).
10) Reduces EPA mandated hazardous waste-oil handling and disposal costs and liabilities by allowing the oil to remain in use for longer periods, possibly for the lifetime of the equipment/vehicle/or vessel.
11) Reduces Nitrous Oxides (NO's), Hydrocarbons (HC's) and CO₂ emissions levels down to, and even less than, current and future EPA mandated Emission requirements, as specified for years 2010 through 2012. This is due to the extreme clean and cooler centrifuged oil retaining higher film strengths between cylinder and piston moving parts, with highest possible lubricity between the piston rings and cylinder walls, thereby increasing the engine's overall compression ratio, and thereby causing a more complete burn of the fuel in the combustion chamber.
12) Due to the related benefits as listed above achieved by the invention, a final observation and continued test have been performed in regards to increased fuel economy. Prior to installation of the present unique centrifuge system, the diesel test vehicle (which began testing at over 218,000 miles) was only capable of reaching approximately 11.4 MPG City, and 14.3 GPM Highway. After installation of the present oil-driven centrifuge system, the test vehicle was put through a little over 5,000 mile test run. During this test run, the fuel economy gradually increased, and towards the first 5,000 mile marker this particular test vehicle increased its city and highway fuel economy by up to 36%.
13) Reduces replacement oil costs by increasing useable oil lifespan, potentially even to the lifetime of the equipment. System viability tested and documented in on-line use for diesel engine application. Additional independent on-line testing and documentation to continue.

### Process and System Description:

The described Oil-Driven Centrifuge, Oil/Fluid Cleaning Unit, is intended for use for by-pass mount configurations (and can be configured for full-flow) on trucks, automotive, or vessels for the purpose of continually cleaning the lubrication oil system in the host machine (engine, transmission, hydraulic, and etc).

The system is comprised of a number of internal components which produce a remarkable level of oil cleanliness in engine, transmission, and hydraulic oils/fluids.

System safeguards can be incorporated into the system (as accessories) by using a low-voltage pressure sensor switch. This switch serves to interrupt power to a servo-valve, and when the centrifuge reaches maximum contaminant holding capacity, a light illuminates on the dash of the operators vehicle or vessel to signal that centrifuge cartridge replacement is necessary.

Process:

The pressurized fluid from the host equipment or engine sends pressurized oil to the inlet port of the centrifuge. Second, the pressurized oil flows up the stationary shaft and out two ports (facing east and west) at the top of the stationary fixed shaft. The rotating centrifuge cartridge shaft provides two or more oil/fluid receiving inlet ports to the centrifuge cartridge, which receives the oil from the stationary fixed shaft. The pressurized oil/fluid is then forced into the high-speed, high RPM rotating centrifuge cartridge through a complex maze of specially designed internal media.
The design of the centrifuge cartridge permits oil/fluid flow to be forced through a series of multiple high-heat, non-corrosive, high-RPM filter media either disc-shaped (donut-shaped), cylindrical-shaped (vertically placed), or sectional, with insert media levels placed either vertically or horizontally (depending upon any variation thereof) which are stacked layers (either one on top of another or side-by-side (each layer encompasses variations in regards to its make-up, thickness, height, length, width, or diameter). The filter media make up is typically comprised of one or more of the following (cotton, cotton cloth, paper media (treated and/or untreated), or any other media variation thereof resembling the coarseness or compressed porosity of the above listed examples. Each section of filter media is divided by a thin separating plate or disc (of any high-heat resistant lightweight material).
   The very thin, separating dividing plates/discs are comprised of non-corrosive, lightweight, high-heat resistant Teflon (or materials with similar properties), or non-corrosive, lightweight, high-heat resistant metallic material (such as tin or any other lightweight metals with similar properties). Each separating dividing plate/disc provides 2, 3, or 4 through holes, about 1/16 inch or ⅛ inch in diameter or any variation thereof regarding their size in diameter, lesser or greater. Holes or oil passageways within each disc are typically placed through the disc by and around the edge, nearest the inner diameter of the disc with out exceeding the edge of the inner diameter of the separating dividing plate/disc.
   The filter media discs as well as the separating plates/discs are provided as one unit with the entire rotating centrifuge cartridge, wherein the inner material is fixed to the inner drum of the rotating centrifuge cartridge as well as fixed to the outer diameter of the rotating part of the rotating centrifuge cartridge. The drum, inner media filtering levels, separating dividing plates/discs/horizontal or vertical sections (depending upon which configuration), shaft, base, drum housing, orifices/outlet ports (oil jets—jet port size and number of jets in the base of the cartridge are typically provided in any variation of sizes and or number of jets), two (2) high-speed ball bearings, and two (2) high-speed needle bearing thrust washers comprising the whole of the rotating centrifuge cartridge as one unit.
   The filter media discs or vertical sections as well as the separating plates/discs can also be provided as separate inner cartridge “inserts” to allow reuse of the main rotating centrifuge cartridge drum and rotating cartridge shaft component(s).
      Note: In today's market, engine oils are now specifically engineered to reduce the chance of engine oil contamination settling or buildup, sometimes marketed as “sludge protection” oil additive formulas. The oils include additives which serve as a dispersant and suspension agent. The centrifuge described herein is typically able to momentarily and deliberately disturb the dispersant/suspension agent additive bond with the present oil contamination; i.e. only momentarily at the point of the centrifuge.
   Each level within the rotating centrifuge cartridge operates by the same means, except that each level becomes less porous than the previous level before it, as the oil is being forced to enter through and across the media. The other variation is that each level of media can be rated for similar porosity, and makeup can be for the same media material all the way through.
   As soon as the pressurized oil reaches the rotating centrifuge cartridge, it pressurizes the latter, full of oil/fluid. The pressurized oil flow along with the introduction of the G-Forces generated by the RPM of the rotating centrifuge cartridge first forces the oil flow in a horizontal outward radial direction across the filter media (causing a “scrubbing action” to momentarily disturb the bond between the oil's contaminants and the oil itself, to allow optimum separation between the contamination, solid particulates, and the oil.
   Second, the pressurized oil is then forced to flow in reverse direction back towards the center of the centrifuge along a path of least resistance along and between the edge of the filter media and the top surface of the separating plate/disc/or sectional divider. Next, the oil is forced to enter into the next level by exiting the upper level through the channel or hole 204a of the separating plate/disc/section located just beneath the filter media and nearest the rotating centrifuge cartridge shaft.
   Variations include different placements of internal parts and media or rerouting of oil flow; such as media and separating divider plates/sections as noted above being placed and stacked in a different position; either a vertical or horizontal position and/or combination of both, or as a vertical cylindrical way in the shape of or not in the shape of the rotating centrifuge cartridge. Note: The design of the media layers and dividing sections as being stacked side-by-side wherein the oil pressure and oil flow forces the oil “north and south”, directly perpendicular to the centrifuge G-Forces, is not preferred since it could run a risk of constant exposure for the shearing effect to occur to the oil molecules (causing smaller and smaller oil molecules to form or possibly even resulting in oil degradation) by means of outward centrifugal force being applied at a constant rate to the “north and south” directions of the pressurized oil flow.
   The unique centrifuge is provided with three installation options. First, the centrifuge can be installed directly onto a valve-cover/bracket assembly (varies between types and sizes of engines). Plumbing (oil-flow conduit) accessories are required to plumb from the oil sending unit of the vehicle to the centrifuge. The centrifuged clean oil then drains from the centrifuge down into the valve cover. This first installation option allows for a complete removal of old i.e. existent valve cover and replacement with above referenced custom valve cover/bracket assembly. Next option for installation is to mount the centrifuge above the level of the oil sump/reservoir, and to plumb pressurized oil to the centrifuge. Third option for installation is for end user to take existent valve cover off and modify structure in order to mount the centrifuge to it. Or and last option, mount centrifuge anywhere on vehicle, plumb to centrifuge from any oil pressure source, and plumb the outlet straight down to the return sump/reservoir.

The unique centrifuge unit demonstrably achieves RPM levels and G-Forces that far exceed those of any other hydraulically-driven bypass filtration system currently on the market.

Note: Other oil driven centrifuges on the market lose there oil cleaning efficiency due to 1) adverse driving or rough road surface conditions, 2) vehicle exceeding minimal or steep grades, which subjects the centrifuges to disadvantages of exceeding their operating limitations of ±10 degrees from vertical mount position.
1.a) Under adverse driving or rough road conditions, standard centrifuges on the market become jarred because of the shock and metal to metal contact between the rotating bushing around the stationary shaft, and then gyration, slowing of the RPMs, and even total stoppage of the rotating device. Constant G-Forces are needed to hold contamination in place within the inner walls of these standard hydraulic centrifuges. When any kind of significant shock occurs, the G-forces drop off significantly or totally, and finally, this results in constant oil pressure from the engine to flush out the entire centrifuges, holding contaminants back into the entire lubrication system.
2.a) Lastly the main reason such standard hydraulically driven centrifuges cannot perform in moderate or steep grade driving conditions is because after 10 degrees tilt from vertical mount position, the oil exiting the oil jets fills up the cavity where the jetted oil needs to hit a solid surface in order to cause propulsion. Jetted oil hitting oil reduces the propulsion factor significantly and will cause the flooded oil to create surface friction between the rotating turbine and the oil itself. This flooding causes the centrifuge to flush out its contaminant contents, once again.
Some centrifuges on the market use a different configuration wherein a portion of the contaminated engine oil pressure is fed directly into a small orifice which drives rotating turbine blades connected to a rotating shaft which drives the centrifuge. The first problem is that they still implement use of bushings to shaft configuration which causes problems as mentioned above. Secondly, the shooting of dirty oil into the cavity where the driving mechanism of the centrifuge is rotating is a huge problem; not only will dirty oil cause premature life in the seals, but leaks, occur. Thirdly, and according to oil engineers, if a process pressurizes contaminated oil volume through a small orifice, then friction occurs right at the point of the orifice and coking of the oil will occur. Coked oil is very abrasive. Fourth, this will cause the orifice or jet to close up over time, much like a clogged artery.
Finally, and internally, standard centrifuge drums are generally empty, and nothing holds contaminants back incase G-Forces drop off under moderate to extreme driving and road conditions.

In applicant's centrifuge configuration, flooding cannot occur because constant propulsion is achieved and high-speed ball bearings are placed around the vertical wall of the shaft of the rotating centrifuge cartridge on both ends of the cartridge (upper and lower ends). The high-speed ball bearings are implemented in the unique oil-driven design to serve the purpose to resist side loading from moderate to adverse driving and rough road environment conditions. The outer races of the high-speed ball bearings, are typically fixed to the rotating structure of the rotating centrifuge cartridge. The entire rotating centrifuge cartridge is removable and replaceable or reusable. The rotating centrifuge cartridge slides onto a stationary fixed (non-rotating) shaft which extends upward from stationary centrifuge housing base. It is important to note that the inner races of the high-speed ball bearings are not fixed to any shaft. Under adverse mobile, driving, rough-road conditions, where side-loading constantly occurs between a fixed shaft and rotating shaft, only then do the inner races of the high-speed ball bearings technically become an active fixed part to the fixed shaft whereby the bearing inner races only intermittently establish contact with the fixed shaft in order to significantly reduce side loading forces between the two shafts to a minimum, if not, completely.

Free floating needle bearing thrust washers on both top and bottom ends of the rotating centrifuge cartridge shaft are included to reduce friction as well as reduce upward and downward loading forces between the top of the rotating centrifuge cartridge shaft and the underneath inside surface where the fixed housing connects to the fixed shaft.

The combination of 1) constant oil/fluid pressure 2) hitting specially designed fixed fins/blades for increased propulsion from the oil exiting the jets, 3) along with high-speed ball bearings and needle bearing thrust washers “load-resisting” design, facilitates optimization of RPM's, G-Forces, and constant acceleration of the rotating centrifuge cartridge even under the most adverse driving and road conditions (including severe angles of operation between vertical or horizontal plane) to which an operator is willing to subject their vehicle to.

### Additional Features

This primary multi-layer centrifuge separator chamber is fitted with a disposable high-speed filtration medium that assists in breaking even sub-micron contaminants loose from the fluid, as well as affecting oil-water separation.

The first stage of the separator can be fitted with multiple layers of the filter medium, segmented with discs to provide additional agitation of the fluid, again assisting in the contaminant removal.

The fluid then passes though into the lower secondary separator chamber, causing another turbulent action to occur that further enhances the separation process.

This multi-layer, multi chamber application achieves the effect of passing the fluid through a series of linked in-line centrifuges, but concentrated into only one centrifuge.

The clean fluid exits the rotating centrifuge cartridge through directional jets, which in turn drive the turbine, and further propulsion is created due to the pressurized exiting clean oil striking multiple fixed or stationary blades/fins.

The fluid ejected through the jets engages a set of angled vanes, of a laser-cut and formed plate configuration, with soldered tubular legs, that are screw mounted within the bottom of the well of the centrifuge base casting. Another version is equipped with vanes that are integrally cast with the centrifuge base casting itself. Both versions function equally well. This vane assembly (or casting) configuration serves two functions. The first is to reduce air entrainment into the jets which would reduce the thrust and hence speed of the spinning drum. The second function is to direct the jets tangentially to the drum, thereby increasing the RPM of the turbine drum assembly aka (rotating centrifuge cartridge). Higher rotational speed translates to higher “G-forces”, and hence increased contaminant separation ability.

To protect the centrifuge, its components, as well as the engine/equipment, incase the centrifuge exceeds its holding capacity, the centrifuge is equipped with a bypass valve mounted into a threaded port in the front of the centrifuge base casting. The fluid then exits the centrifuge through a larger port on the opposite side of the centrifuge base casting from the inlet port.

I claim:

1. An individual component assembly for filtering fluid, comprising, in combination:
a) a centrifuge device operable to filter said fluid,
b) stand structure mounting said centrifuge device, to be directly accessible,
c) at least one fluid filter connected in operating flow passing series with the centrifuge, and openly and accessibly carried by the stand structure,
d) pumping means associated with the stand structure for pumping fluid to flow through said fluid filter and then through the centrifuge.

2. The combination of claim 1 including an additional fluid filter connected in operative flow passing series with said one filter and said centrifuge device, and openly and accessibly carried by said stand structure.

3. The combination of claim 1 including first bracket means supporting said one filter on the stand structure, and sidewardly of the centrifuge device.

4. The combination of claim 2 including first and second brackets respectively supporting said one filter and said additional filter, at upper and lower levels, respectively, on the stand structure.

5. The combination of claim 4 wherein said one filter is a pre-filter connected to filter the fluid prior to fluid communication to the centrifuge device, and said additional filter is a polishing filter connected to filter fluid communicated downwardly from the centrifuge device.

6. The combination of claim 2 wherein the centrifuge device is located at the top of the stand structure, and the two filters are typically accessibly carried at external sides of the stand structure, to provide a highly compact efficient assembly, with directly accessible components enabling rapid filtering media changes.

7. The combination of claim 6 wherein the pumping means is also accessibly carried at an external side of the stand structure.

8. The combination of claim 6 wherein the assembly includes a centrifuge drive turbine located directly below filtering structure in the centrifuge, whereby fluid discharged from the drive turbine is sucked downwardly by and to the pumping means.

9. The combination of claim 8 wherein the centrifuge device includes
i) an upright shaft, defining an axis, extending downwardly in the stand structure,
ii) porting extending endwise in the shaft and opening laterally to the centrifuge interior to deliver flow to be centrifuged,
iii) generally radial passages in the chamber interior into which contaminant in the delivered fluid is centrifuged for separation from the fluid, during chamber high-speed rotation;
iv) a rotor supporting the chamber for rotation about the axis, there being at least one outlet for fluid discharged from the chamber,
v) a fluid pressure driven turbine connected in driving relation with the rotor,
vi) pumping means connected to draw fluid discharged by the turbine, for supply to a polishing filter,
vii) there being a pre-filter via which fluid to be centrifuged is passed and filtered to be pumped by said pumping means for delivering to said porting in the shaft.

10. The combination of claim 1 including a heat conducting metallic housing for the centrifuge device, and heat radiating fins on the housing.

11. The combination of claim 10 wherein the fins consist of one of the following:
i) copper
ii) copper alloy.
